(19) United States
(12) Patent Application Publication
(10) Pub. No.: US 2026/0287989 A1
(43) Pub. Date: Sep. 24, 2026

(54) PROJECTOR DEVICE

(71) Applicant: SEIKO EPSON CORPORATION, Tokyo (JP)

(72) Inventors: Hiroyuki KAMIJO, MATSUMOTO-SHI, NAGANO-KEN (JP); Yusaku TAKAMINE, AZUMINO-SHI, NAGANO-KEN (JP); Nobuyuki OTSUKI, MATSUMOTO-SHI, NAGANO-KEN (JP)

(21) Appl. No.: 19/570,247

(22) Filed: Mar. 18, 2026

(30) Foreign Application Priority Data
Mar. 21, 2025 (JP) 2025-046502

(51) Int. Cl. G03B 21/14

(52) U.S. Cl. CPC G03B 21/145

(57) ABSTRACT

A projector device includes: an installation base installed at an installation surface; a support part erected from the installation base; a coupling part having a rotation axis along a direction orthogonal to a direction of extension of the support part and provided at one end of the support part; and a projector main body coupled to the coupling part so as to be rotationally movable about the rotation axis with respect to the support part, and the projector main body has a bottom surface located on the installation base side, a top surface opposite to the bottom surface, and a recess recessed from the bottom surface toward the top surface, and at least a part of the coupling part coupled to the projector main body is disposed in the recess.

The present application is based on, and claims priority from JP Application Serial Number 2025-046502, filed Mar. 21, 2025, the disclosure of which is hereby incorporated by reference herein in its entirety.

### BACKGROUND

### 1. Technical Field

The present disclosure relates to a projector device.

### 2. Related Art

According to the related art, a projector configured such that a tripod can be attached thereto is known (refer to, for example, JP-A-2024-86921).

A screw hole corresponding to the standard of a fixing screw provided at the head of a tripod is provided in the bottom surface of the projector described in JP-A-2024-86921. The projector is fixed to the head as the fixing screw provided at the head is screwed into the screw hole.

JP-A-2024-86921 is an example of the related art.

Here, when the projector is rotated around a predetermined rotation axis, if the center of gravity of the projector and the rotation axis are separated from each other, there is a problem in that the torque required for the rotation of the projector increases and thus the operability for rotating the projector deteriorates.

Therefore, in the projector described in JP-A-2024-86921, when the rotation axis along the horizontal direction formed by the tripod and the center of gravity of the projector are separated from each other, the torque for turning the projector up and down increases, posing a risk of impaired operability.

For this reason, there has been a demand for a configuration that enables improvement in operability.

### SUMMARY

A projector device according to a first aspect of the present disclosure includes: an installation base installed at an installation surface; a support part erected from the installation base; a coupling part having a rotation axis along a direction orthogonal to a direction of extension of the support part and provided at one end of the support part; and a projector main body coupled to the coupling part so as to be rotationally movable about the rotation axis with respect to the support part, and the projector main body has a bottom surface located on the installation base side, a top surface opposite to the bottom surface, and a recess recessed from the bottom surface toward the top surface, and at least a part of the coupling part coupled to the projector main body is disposed in the recess.

A projector device according to a second aspect of the present disclosure includes: a projector main body; a projector support part that supports the projector main body; and an installation base where the projector support part is disposed, and the projector support part includes a rotating part that is disposed at one end of the projector support part, is fixed to the projector main body, and supports the projector main body rotatably about a rotation axis orthogonal to a direction of extension of the projector support part, and the rotating part is covered by the projector main body in a circumferential direction about an axis along the direction of extension.

### BRIEF DESCRIPTION OF THE DRAWINGS

FIG. 1 is a perspective view showing a projector device according to an embodiment.

FIG. 2 is a perspective view showing the projector device according to the embodiment.

FIG. 3 shows an image projection device provided in a projector main body according to the embodiment.

FIG. 4 is a cross-sectional view showing the projector main body according to the embodiment.

FIG. 5 is a perspective view showing a coupling member and a stand according to the embodiment.

FIG. 6 is a perspective view showing the coupling member and the stand according to the embodiment.

FIG. 7 is a side view showing the projector device with a cover member removed according to the embodiment.

FIG. 8 shows a bottom surface of the projector main body according to the embodiment.

FIG. 9 shows the projector main body in a state where a lower case is removed according to the embodiment.

FIG. 10 shows the projector main body in a state where the coupling member and the lower case are removed according to the embodiment.

FIG. 11 is a cross-sectional view showing the projector main body with the coupling member attached according to the embodiment.

FIG. 12 is a plan view showing the center of gravity of the projector main body according to the embodiment.

### DESCRIPTION OF EMBODIMENTS

Hereinafter, an embodiment of the present disclosure will be described with reference to the drawings.

### Schematic Configuration of Projector Device

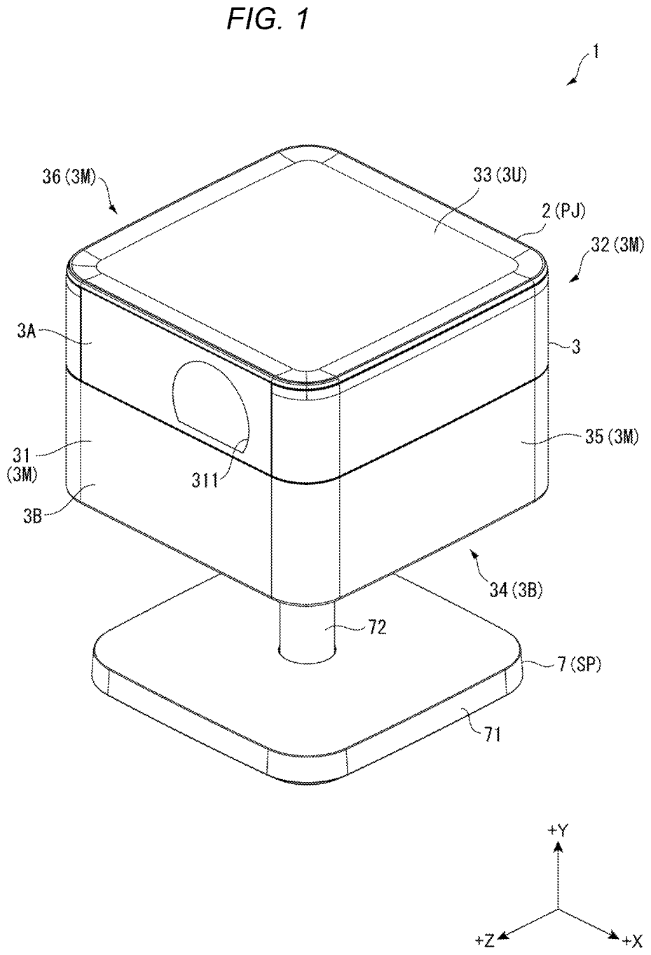

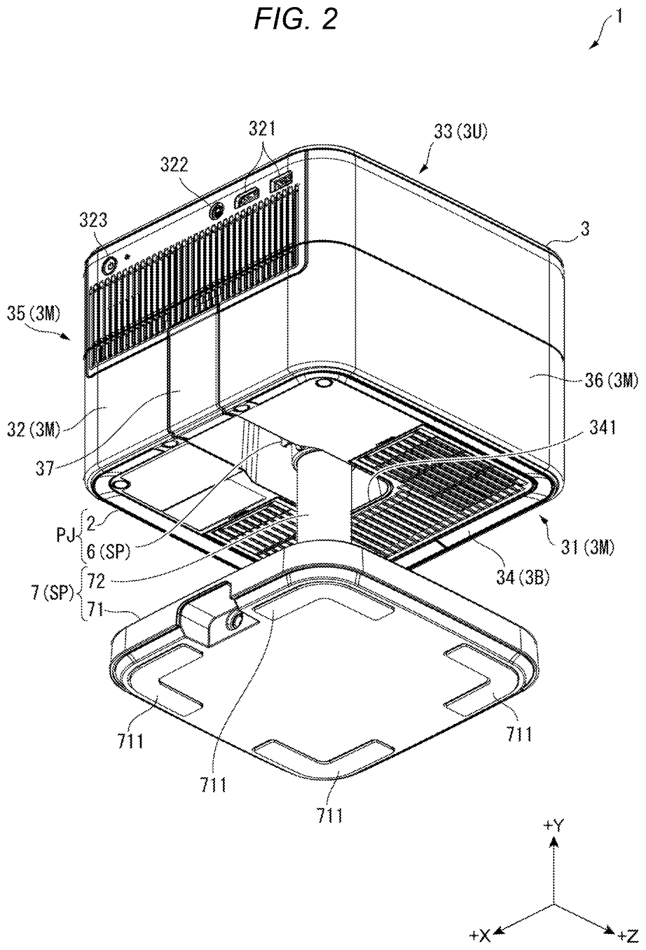

FIGS. 1 and 2 are perspective views showing a projector device 1 according to the present embodiment. Specifically, FIG. 1 is a perspective view showing the projector device 1 as viewed from an image light projection side, and FIG. 2 is a perspective view showing the projector device 1 as viewed from the side opposite to the image light projection side.

The projector device 1 according to the present embodiment includes a projector main body 2, a coupling member 6, and a stand 7, and can be said to be a stand-equipped projector in which the stand 7 is coupled to the coupling member 6 attached to the projector main body 2. In other words, the projector main body 2 and the coupling member 6 form a projector PJ, and the projector device 1 is formed by the projector PJ and the stand 7.

Hereinafter, each configuration in the projector device 1 will be described in detail.

### Configuration of Projector Main Body

The projector main body 2 is configured to project image light corresponding to image information, and is a projector that can be used alone. The projector main body 2 includes an exterior housing 3.

The exterior housing 3 has a front surface 31, a back surface 32, a top surface 33, a bottom surface 34, a right side surface 35, and a left side surface 36, and is formed in a substantially rectangular parallelepiped shape.

The front surface 31 and the back surface 32 are surfaces facing opposite to each other.

The front surface 31 has a projection port 311 through which image light projected from an image projection device 4, described later, passes.

The back surface 32 includes a plurality of terminals 321 to which a video cable can be coupled, a terminal 322 to which an earphone can be coupled, and a power button 323. A cover member 37 forming a part of the back surface 32 is detachably provided at the back surface 32.

The cover member 37 is a member that closes, on the back surface 32 side, a recess 341 provided at the bottom surface 34 and opening to the back surface 32. The cover member 37 is attachable to and detachable from the back surface 32, and is detached from the back surface 32 when the coupling member 6, described later, is coupled to the stand 7.

The top surface 33 and the bottom surface 34 are surfaces facing opposite to each other. As shown in FIG. 2, the bottom surface 34 has the recess 341 recessed toward the top surface 33, and the bottom of the recess 341 is provided with an opening, not illustrated, through which an attachment part 461 of a base 46, described later, is exposed.

The right side surface 35 and the left side surface 36 are surfaces facing opposite to each other.

The exterior housing 3 is configured with an upper case 3U, a middle case 3M, and a lower case 3L combined together.

The middle case 3M forms the front surface 31, the back surface 32, the right side surface 35, the left side surface 36, and a part of the bottom surface 34.

The upper case 3U is attached to the middle case 3M and forms the top surface 33.

The lower case 3L is attached to the middle case 3M and forms another part of the bottom surface 34.

The exterior housing 3 includes an upper housing part 3A including the upper case 3U and an upper part of the middle case 3M, and a lower housing part 3B including the lower case 3L and a lower part of the middle case 3M.

In the following description, three directions perpendicular to one another are defined as a +X direction, a +Y direction, and a +Z direction. Of these, the +Z direction is the direction in which the front surface 31 faces, the +Y direction is the direction in which the top surface 33 faces, and the +X direction is the direction in which the right side surface 35 faces.

Although not shown in the drawings, the direction opposite to the +X direction is defined as a −X direction, the direction opposite to the +Y direction is defined as a −Y direction, and the direction opposite to the +Z direction is defined as a −Z direction.

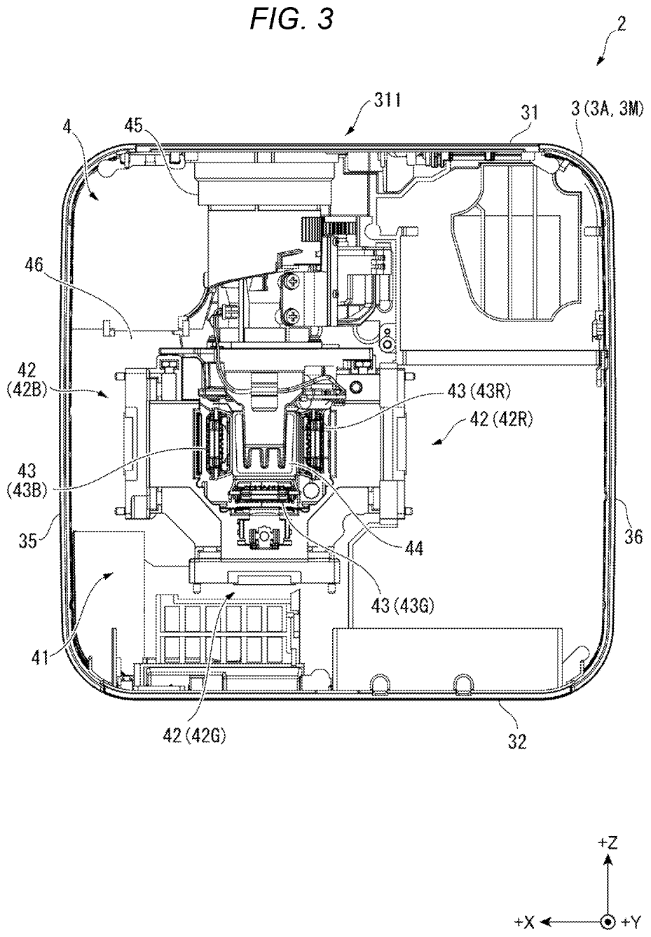

FIG. 3 shows the image projection device 4 provided in the projector main body 2. In other words, FIG. 3 is a plan view of the projector main body 2 from which the upper case 3U is removed, as viewed from the +Y direction.

The projector main body 2 includes the image projection device 4 and a speaker unit 5 accommodated in the exterior housing 3. In addition, although not illustrated in the drawings, the projector main body 2 includes a control device that controls the operation of the projector main body 2, a power supply device that supplies power to electronic components of the projector main body 2, and a cooling device that cools a cooling target in the projector main body 2.

As illustrated in FIG. 3, the image projection device 4 is accommodated in the upper housing part 3A, forms image light corresponding to image information, and projects the formed image light. The image projection device 4 includes an image forming device 41, a projection optical device 45, and the base 46.

The image forming device 41 includes a light source device 42, a light modulation device 43, and a light combining device 44. Each of the light source device 42, the light modulation device 43, and the light combining device 44 is equivalent to an optical component.

The light source device 42 emits light that becomes incident on the light modulation device 43. In the present embodiment, the light source device 42 includes a red light source 42R that emits red light, a green light source 42G that emits green light, and a blue light source 42B that emits blue light. As an example of each of the light sources 42R, 42G, 42B, a configuration including a light emitting element such as a light emitting diode (LED) that emits corresponding color light and a substrate that supports the light emitting element can be provided.

The light modulation device 43 modulates the light emitted from the light source device 42 in accordance with an image signal input from the above-described control device. The light modulation device 43 includes a red light modulation element 43R that modulates the red light, a green light modulation element 43G that modulates the green light, and a blue light modulation element 43B that modulates the blue light. As an example of the light modulation elements 43R, 43G, 43B, a transmissive liquid crystal light valve including a liquid crystal panel, and an incident-side polarizing plate and an exiting-side polarizing plate sandwiching the liquid crystal panel, can be provided.

The light combining device 44 combines the red light modulated by the red light modulation element 43R, the green light modulated by the green light modulation element 43G, and the blue light modulated by the blue light modulation element 43B and thus forms image light. The light combining device 44 emits the formed image light toward the projection optical device 45. As an example of the light combining device 44, a cross dichroic prism formed in a substantially rectangular parallelepiped shape can be provided.

The projection optical device 45 is one of the optical components and projects the image light emitted from the light combining device 44. The image light projected by the projection optical device 45 is projected onto a projection surface such as a screen via the projection port 311. As an example of the projection optical device 45, a lens assembly including a plurality of lenses and a lens barrel accommodating the plurality of lenses can be provided.

The base 46 is a plate-shaped member formed of resin or metal, is disposed in the upper housing part 3A, and supports the light source device 42, the light modulation device 43, the light combining device 44, and the projection optical device 45. As will be described in detail later, the base 46 has the attachment part 461 to which the coupling member 6 is attached.

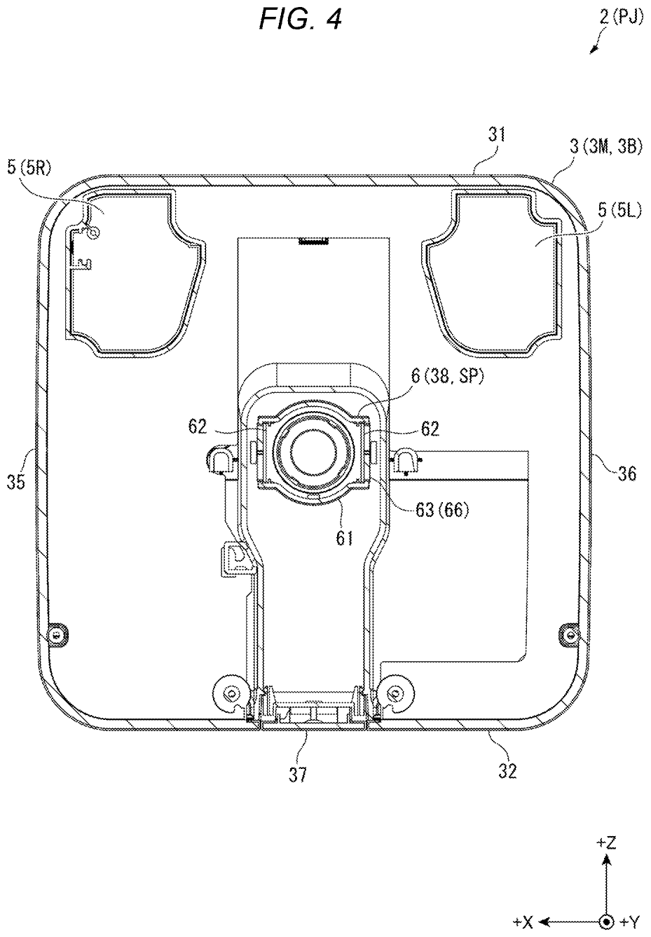

FIG. 4 is a diagram showing a cross section of the projector main body 2 along an XZ plane in the lower housing part 3B.

The speaker unit 5 outputs a sound corresponding to a sound signal input from the above-described control device. As shown in FIG. 4, the speaker unit 5 includes a right speaker 5R and a left speaker 5L.

The right speaker 5R outputs a right sound corresponding to a right sound signal input from the control device. The right speaker 5R is provided at a position on the front surface 31 side and the right side surface 35 side in the lower housing part 3B.

The left speaker 5L outputs a left sound corresponding to a left sound signal input from the control device. The left speaker 5L is provided at a position on the front surface 31 side and the left side surface 36 side in the lower housing part 3B. A power supply device may be disposed instead of one of the right speaker 5R and the left speaker 5L, and a control device may be disposed instead of the other speaker. That is, another configuration may be disposed instead of the speaker unit 5. The center of gravity of the projector main body 2 can be lowered as heavy objects such as the right speaker 5R and the left speaker 5L are disposed on the lower side of the exterior housing 3 surrounding the coupling member 6, described later. That is, the center of gravity of the projector main body 2 can be located further in the −Y direction. The load on the coupling member 6 can thus be reduced, and the stand 7 and a projector support part SP, described later, can stably support the projector main body 2 in a rotatable manner.

### Configuration of Stand

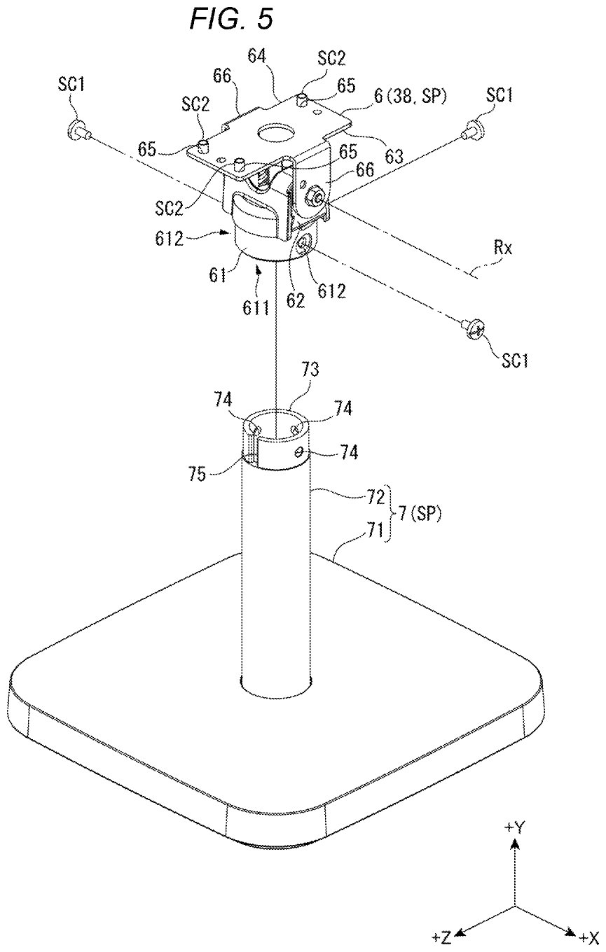

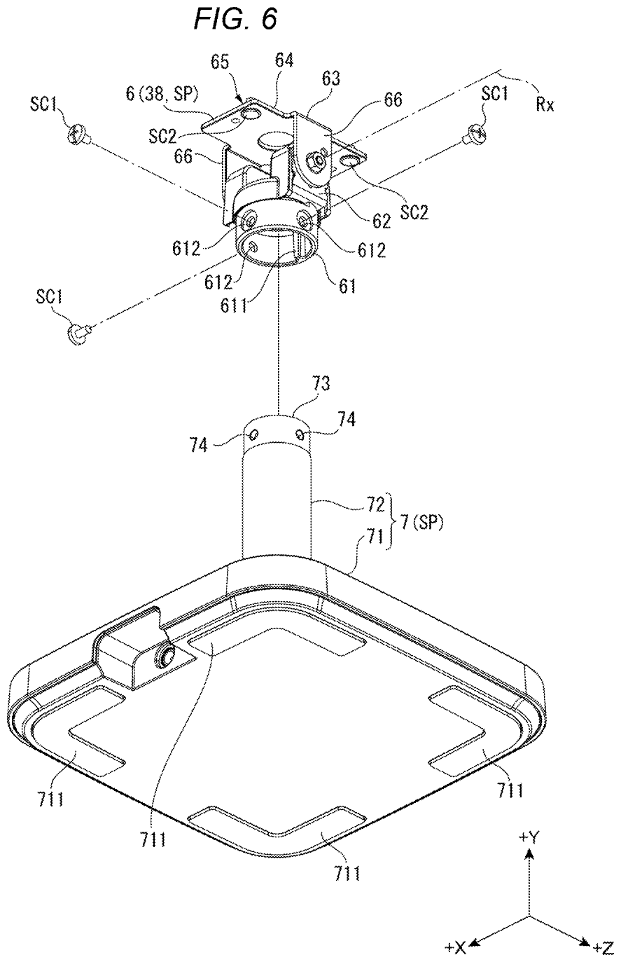

FIGS. 5 and 6 are perspective views showing the coupling member 6 and the stand 7. Specifically, FIG. 5 is a perspective view showing the coupling member 6 and the stand 7 as viewed from above, and FIG. 6 is a perspective view showing the coupling member 6 and the stand 7 as viewed from below.

The stand 7 will be described prior to the description of the coupling member 6.

As shown in FIGS. 1 and 2, the stand 7 is coupled to the coupling member 6 attached to the projector main body 2 and supports the projector main body 2. As shown in FIGS. 1, 2, 5, and 6, the stand 7 includes an installation base 71 and a support part 72, and is formed by a combination of the installation base 71 and the support part 72.

The installation base 71 is a pedestal installed at an installation surface such as a table and a floor surface, and is formed in a flat and substantially rectangular parallelepiped shape. An elastic member 711 formed of rubber or the like is provided at the four corners of the surface of the installation base 71 facing the installation surface.

The support part 72 is one rod-shaped member vertically erected from the installation base 71. The support part 72 includes an engaging part 73 provided at a distal end part of the support part 72 opposite to the installation base 71.

The engaging part 73 is a part that engages with the coupling member 6. The engaging part 73 has a plurality of screw holes 74 and a positioning groove 75.

The plurality of screw holes 74 are provided in the vicinity of the end part in the +Y direction on the outer peripheral surface centered on the central axis of the support part 72 along the +Y direction, and three screw holes 74 are provided in the present embodiment. Each of the three screw holes 74 penetrates the cylindrical support part 72. A screw SC1 inserted through the coupling member 6 is fixed into each of the three screw holes 74, and the support part 72 and the coupling member 6 are thus fixed together. In the present embodiment, the screw holes 74 are provided at a position of 0°, a position of 90°, and a position of 270°, respectively, when the support part 72 is viewed from the +Y direction.

The positioning groove 75 is a groove part formed along the +Y direction and is provided at a position of 180° when the support part 72 is viewed from the +Y direction. A positioning protrusion 611 of the coupling member 6 is inserted into the positioning groove 75.

Hereinafter, the direction of extension of the support part 72 from the installation base 71 is defined as a +D direction, and the direction opposite to the +D direction is defined as a −D direction.

### Configuration of Coupling Member

The coupling member 6 is attached to the projector main body 2 to form a coupling part 38 provided in the exterior housing 3, and is also combined with the support part 72 to form the projector support part SP, as shown in FIGS. 5 and 6. The projector support part SP supports the projector main body 2.

The coupling member 6 is coupled to the support part 72 and thus couples the projector main body 2 and the stand 7. When the coupling member 6 is coupled to the stand 7, the coupling member 6 enables the projector main body 2 to rotate about a rotation axis Rx along the +X direction. In other words, the coupling member 6 is equivalent to a rotating part that is disposed at one end of the projector support part SP, is fixed to the projector main body 2, and supports the projector main body 2 rotatably about the rotation axis Rx orthogonal to the direction of extension of the projector support part SP.

At least a part of the coupling member 6 is disposed in the recess 341 of the bottom surface 34 illustrated in FIG. 2. In the present embodiment, the entire coupling member 6 is disposed in the recess 341.

As illustrated in FIGS. 5 and 6, the coupling member 6 includes a mounting part 61, a rotation support part 62, and a fixing part 63.

The mounting part 61 is a part mounted at an end part of the support part 72. The mounting part 61 is formed in a cylindrical shape and is mounted so as to cover the upper end and a part of the outer peripheral surface of the support part 72. The mounting part 61 includes the positioning protrusion 611 and a plurality of hole parts 612.

When the coupling member 6 is mounted at the support part 72, the positioning protrusion 611 is inserted into the positioning groove 75 from the +Y direction. Thus, the coupling member 6 is positioned with respect to the support part 72.

The plurality of hole parts 612 are provided corresponding to the plurality of screw holes 74. In each of the plurality of hole parts 612, the screw SC1 fixed to the corresponding screw hole 74 of the plurality of screw holes 74 is inserted. The process of attaching the stand 7 to the projector main body 2 with the coupling member 6 fixed thereto will be described in detail later.

The rotation support parts 62 are a pair of protruding parts protruding in the +D direction from the mounting part 61. The rotation support part 62 supports the fixing part 63 rotatably about the rotation axis Rx.

The fixing part 63 is a part fixed to the projector main body 2 while being supported by the rotation support part 62. The fixing part 63 includes a contact part 64, an insertion hole 65, and a pair of arm parts 66.

The contact part 64 is formed in a substantially rectangular plate shape and comes into contact with the projector main body 2. The contact part 64 is provided with a plurality of insertion holes 65.

The insertion holes 65 are provided respectively at three corners of the four corners of the contact part 64. The insertion hole 65 is a hole part penetrating the contact part 64 along the +D direction. As a screw SC2, which is a fixing member inserted through the insertion hole 65 in the +D direction, is fixed to the projector main body 2, the contact part 64 is fixed to the projector main body 2, and the coupling member 6 is thus fixed to the projector main body 2.

Each of the pair of arm parts 66 extends downward from the contact part 64 and is supported by the rotation support part 62 so as to be rotatable about the rotation axis Rx. Thus, the fixing part 63 fixed to the projector main body 2 is supported by the rotation support part 62 so as to be rotatable about the rotation axis Rx.

### Configuration of Attachment Part of Projector Main Body

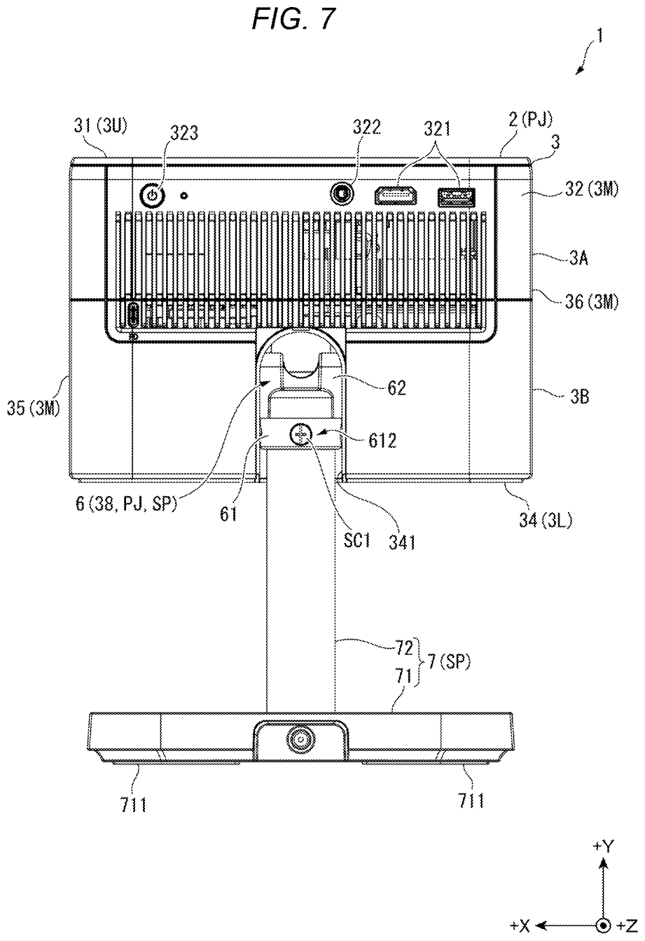

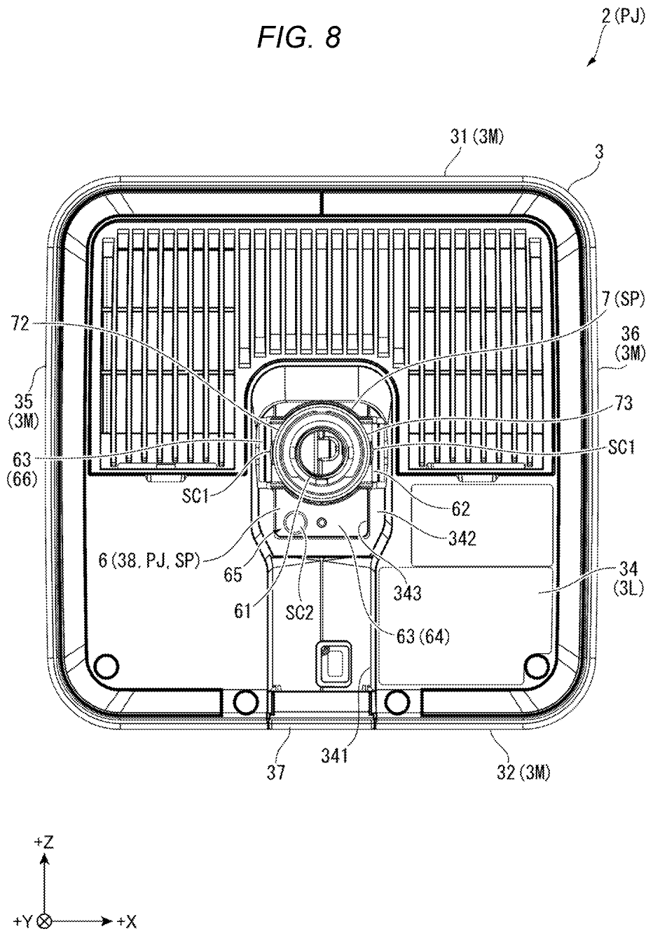

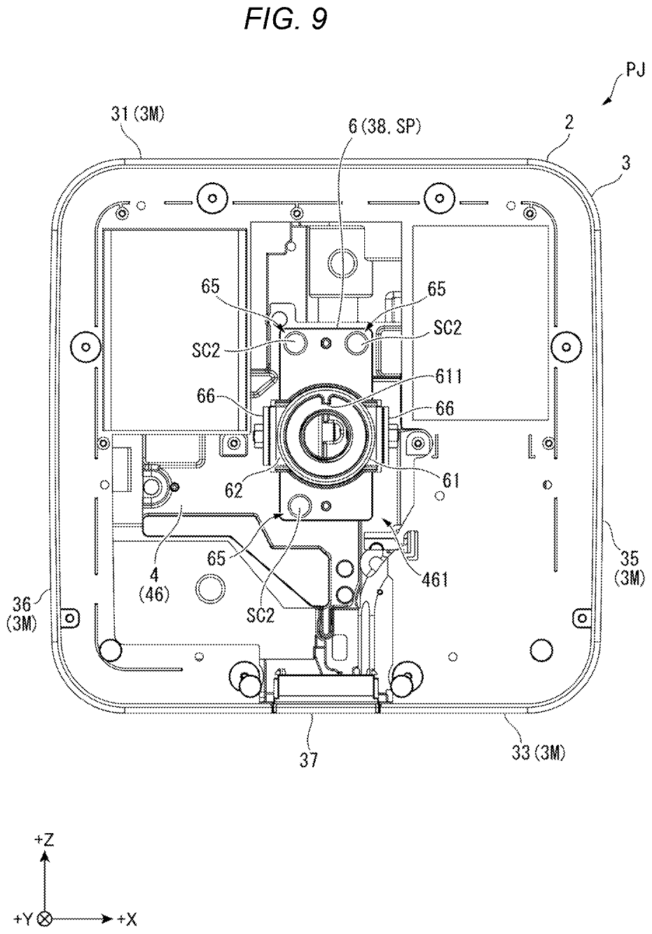

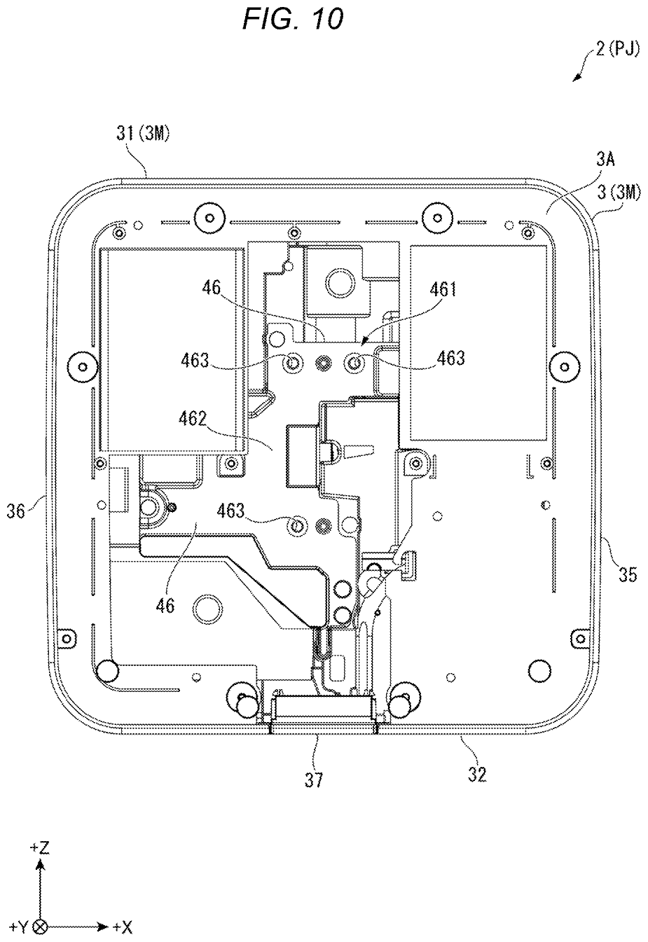

FIG. 7 is a side view of the projector device 1 as viewed from the −Z direction in a state where the cover member 37 is removed. FIG. 8 is a diagram of the bottom surface 34 of the projector main body 2 as viewed from the −Y direction, and FIG. 9 is a diagram of the projector main body 2 as viewed from the −Y direction in a state where the lower case 3L is removed. In FIG. 9, the stand 7 is not shown. FIG. 10 shows the projector main body 2 in a state where the coupling member 6 and the lower case 3L are removed.

As described above, as shown in FIGS. 7 to 9, the coupling member 6 is disposed in the recess 341 provided in the bottom surface 34. As shown in FIGS. 9 and 10, the coupling member 6 is fixed to the base 46 exposed in the −Y direction as the lower case 3L is removed. As shown in FIG. 10, the base 46 has the attachment part 461 to which the coupling member 6 is attached.

The attachment part 461 has a contact surface 462 and a plurality of screw holes 463.

The contact surface 462 is a surface facing the −Y direction in the base 46 and is formed to be substantially flat. The contact part 64 of the coupling member 6 comes into contact with the contact surface 462. That is, the contact surface 462 is a part to which the coupling member 6 is coupled, and is located between the top surface 33 and the bottom surface 34 in the projector main body 2. That is, the projector main body 2 is coupled to the coupling part 38 formed of the coupling member 6 between the bottom surface 34 and the top surface 33.

The screws SC2 inserted through the insertion holes 65 of the contact part 64 are fixed into the plurality of screw holes 463. In the present embodiment, three screw holes 463 are provided, corresponding to the number of insertion holes 65.

After the coupling member 6 is attached to the attachment part 461, the lower case 3L is fixed to the middle case 3M and thus the coupling member 6 is disposed in the recess 341 provided in the lower case 3L. A part of the coupling member 6 attached to the attachment part 461 overlaps a part of the projection optical device 45, when viewed from the +Y direction.

In the present embodiment, the recess 341 is provided in the lower case 3L, but may be provided in the middle case 3M. In this case, the lower case 3L may be provided with an opening that communicates with the recess 341 and into which the support part 72 can be inserted.

### Mounting of Stand on Projector Main Body

When the stand 7 is to be mounted on the projector main body 2, the coupling member 6 is first attached to the attachment part 461 of the projector main body 2. At this time, the lower case 3L is removed from the projector main body 2, and the coupling member 6 is attached to the attachment part 461 with the screws SC2 in a state where the attachment part 461 of the base 46 is exposed. Subsequently, the lower case 3L is attached to the projector main body 2. As described above, the coupling member 6 coupled to the projector main body 2 is surrounded and covered by the front surface 31, the back surface 32, the right side surface 35, and the left side surface 36 in the circumferential direction around the axis along the +Y direction, as shown in FIG. 2. Each of the front surface 31, the back surface 32, the right side surface 35, and the left side surface 36 is equivalent to a side surface coupling the top surface 33 and the bottom surface 34.

Then, the mounting part 61 of the coupling member 6 and the engaging part 73 of the support part 72 are positioned with each other such that the positioning protrusion 611 of the mounting part 61 is inserted into the positioning groove 75 of the engaging part 73. Thus, the plurality of hole parts 612 of the mounting part 61 and the plurality of screw holes 74 of the engaging part 73 coincide with each other.

Subsequently, in the state where the cover member 37 is removed from the projector main body 2, as shown in FIG. 7, the coupling member 6 and the stand 7 are fixed to each other with the screws SC1 inserted into the plurality of hole parts 612 and the plurality of screw holes 74. At this time, the projector main body 2 is sequentially rotated relatively to the stand 7 around the rotation axis along the +Y direction by the coupling member 6 such that one hole part 612 of the plurality of hole parts 612 is exposed in the −Z direction, and the screw SC1 is inserted into the hole part 612 and fixed into the screw hole 74. After the screws SC1 are fixed into the screw holes 74, the cover member 37 is mounted.

Thus, the stand 7 is coupled to the coupling member 6, and the stand 7 is mounted on the projector main body 2.

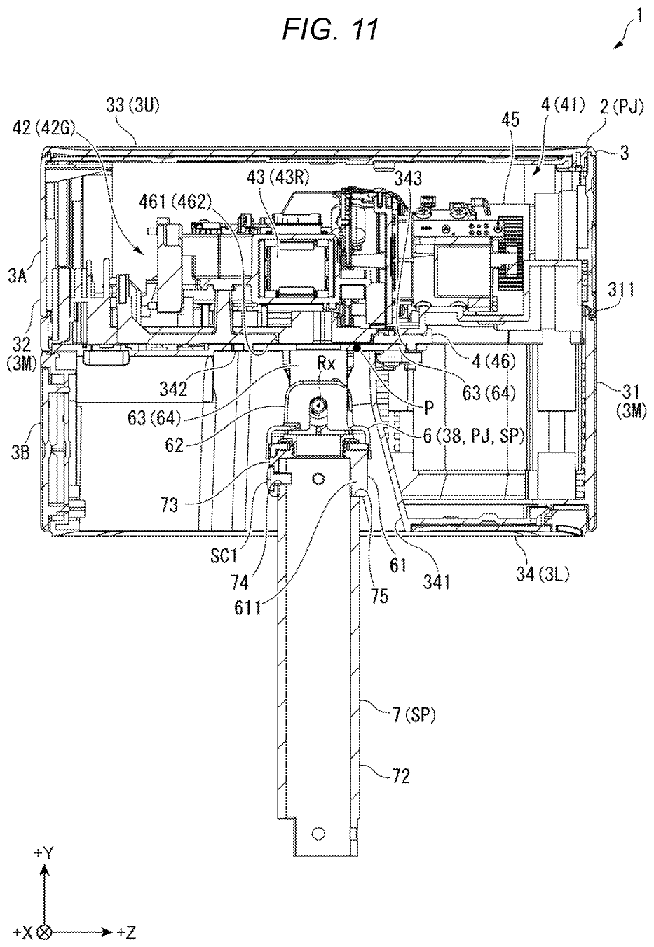

FIG. 11 shows a cross section along a YZ plane of the projector main body 2 with the coupling member 6 attached thereto. That is, FIG. 11 shows a cross section of the projector PJ along the YZ plane.

In the projector main body 2 with the stand 7 mounted thereon in this manner, the periphery of the coupling member 6 around the axis along the +Y direction is surrounded by the exterior housing 3, as shown in FIGS. 7 and 11. Specifically, in the coupling member 6 and the stand 7, the peripheries of the mounting part 61 and the engaging part 73 around the axis along the +Y direction are surrounded by the exterior housing 3.

Thus, the coupling member 6 disposed inside the projector main body 2 can be made less likely to be observed from outside the projector main body 2, and the engaging part 73 of the stand 7 coupled to the coupling member 6 can be made less likely to be observed. Therefore, the appearance of the projector device 1 can be improved.

### Position of Center of Gravity of Projector Main Body

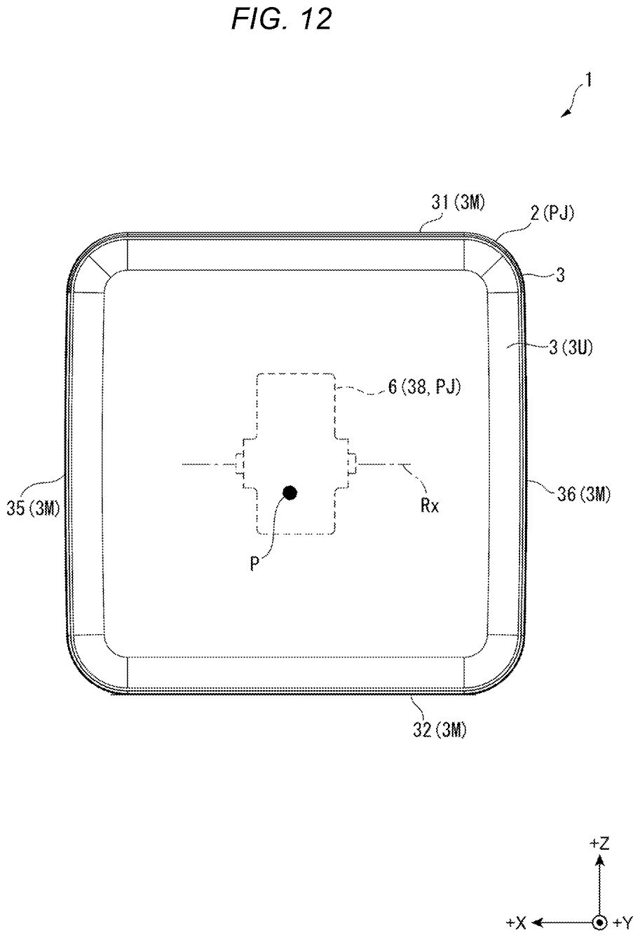

FIG. 12 is a plan view showing the projector device 1 as viewed from the +Y direction and shows the center of gravity P of the projector main body 2. In FIG. 12, the position of the coupling member 6 is indicated by a dotted line.

As shown in FIG. 12, the center of gravity P of the projector main body 2 when viewed from the +Y direction, which is the top surface 33 side, is set at a position overlapping the coupling member 6. Although not illustrated in detail, the center of gravity P is set at a position overlapping the coupling member 6 and the support part 72 when viewed from the +Y direction. In other words, the center of gravity P, the coupling member 6, and the support part 72 overlap each other in the +Y direction.

Meanwhile, as shown in FIG. 11, the center of gravity P of the projector main body 2 when viewed from the −X direction is set at a position overlapping the coupling member 6. That is, when viewed from the −X direction perpendicular to the left side surface 36, a first distance between the rotation axis Rx and the center of gravity P of the projector main body 2 is shorter than a second distance between the center of gravity P of the projector main body 2 and the bottom surface 34.

Therefore, the center of gravity P of the projector main body 2 and the rotation axis Rx are closer to each other than when the coupling member 6 is mounted on the bottom surface 34.

Thus, the torque for rotating the projector main body 2 around the rotation axis Rx can be reduced. Therefore, the operability for performing the rotating operation on the projector main body 2 can be improved.

### Effects of Embodiment

The projector device 1 according to the present embodiment described above achieves the following effects.

The projector device 1 includes the projector main body 2, the coupling member 6, the installation base 71, and the support part 72.

The installation base 71 is installed at the installation surface. The support part 72 is erected from the installation base 71.

The coupling member 6 forms the coupling part 38 attached to the projector main body 2. The coupling member 6 has the rotation axis Rx along a direction orthogonal to the direction of extension of the support part 72. When the coupling member 6 is attached to the support part 72, the coupling member 6 is provided at one end of the support part 72 opposite to the installation base 71.

The projector main body 2, which projects image light, is coupled to the coupling member 6 so as to be rotatable about the rotation axis Rx with respect to the support part 72.

The projector main body 2 has the bottom surface 34, the top surface 33, and the recess 341. The bottom surface 34 is a surface located on the installation base 71 side, and the top surface 33 is a surface opposite to the bottom surface. The recess 341 is recessed from the bottom surface 34 toward the top surface 33.

At least a part of the coupling member 6 coupled to the projector main body 2 is disposed in the recess 341.

Here, the torque for rotating the projector main body 2 around the rotation axis Rx increases according to the distance between the rotation axis Rx and the center of gravity P of the projector main body 2.

However, the coupling position of the coupling member 6 with respect to the projector main body 2 can be brought closer to the top surface 33 side than when the coupling member 6 is coupled to the bottom surface 34, and therefore the rotation axis Rx and the center of gravity P of the projector main body 2 can be prevented from being far apart from each other. Since the distance between the rotation axis Rx of the coupling member 6 and the center of gravity P of the projector main body 2 can thus be reduced, the above-described torque can be reduced. Therefore, the operability for rotating the projector main body 2 can be improved.

In the projector device 1, the projector main body 2 is coupled to the coupling member 6 between the bottom surface 34 and the top surface 33. That is, the contact part of the coupling member 6 with respect to the projector main body 2 is located between the bottom surface 34 and the top surface 33.

According to such a configuration, the distance between the center of gravity P of the projector main body 2 and the rotation axis Rx of the coupling member 6 can be made shorter than when the projector main body 2 is coupled to the coupling member 6 at the bottom surface 34. Therefore, since the above-described torque can be further reduced, the operability for rotating the projector main body 2 can be improved further.

In the projector device 1, the projector main body 2 has the front surface 31, the back surface 32, the right side surface 35, and the left side surface 36, which are side surfaces coupling the top surface 33 and the bottom surface 34.

For example, when viewed from a direction perpendicular to the left side surface 36, the distance between the rotation axis Rx and the center of gravity P is shorter than the distance between the center of gravity P and the bottom surface 34. The distance between the rotation axis Rx and the center of gravity P is equivalent to the first distance, and the distance between the center of gravity P and the bottom surface 34 is equivalent to the second distance.

According to such a configuration, as described above, the distance between the center of gravity P and the rotation axis Rx can be made shorter than when the projector main body 2 is coupled to the coupling member 6 at the bottom surface 34. Therefore, since the above-described torque can be further reduced, the operability for rotating the projector main body 2 can be improved further.

In the projector device 1, the projector main body 2 has the front surface 31, the back surface 32, the right side surface 35, and the left side surface 36, which are side surfaces coupling the top surface 33 and the bottom surface 34.

For example, when viewed from the +Z direction perpendicular to the front surface 31 and the back surface 32, the coupling member 6 attached to the projector main body 2 is covered by the front surface 31 and the back surface 32. Also, for example, when viewed from the +X direction perpendicular to the right side surface 35 and the left side surface 36, the coupling member 6 attached to the projector main body 2 is covered by the right side surface 35 and the left side surface 36.

According to such a configuration, since the projector main body 2 has the side surfaces covering the coupling member 6, the center of gravity P can be easily set on the bottom surface 34 side, and thus the center of gravity P can be easily brought close to the coupling member 6. Thus, the distance between the center of gravity P and the rotation axis Rx can be easily reduced, and the above-described torque can be easily reduced.

Also, since the coupling member 6 is covered by the front surface 31, the back surface 32, the right side surface 35, and the left side surface 36, the coupling member 6 can be made less likely to be observed from outside. Therefore, the appearance of the projector device 1 can be improved.

In the projector device 1, the support part 72 has the engaging part 73 engaging with the mounting part 61 of the coupling member 6. When the mounting part 61 and the engaging part 73 are engaged with each other, the engaging part 73 is covered by the projector main body 2 as viewed from the ±X direction or the ±Z direction orthogonal to the +Y direction, which is the direction of extension of the support part 72.

According to such a configuration, since the engaging part 73, which is the part of the support part 72 engaged with the coupling member 6, is covered by the projector main body 2 as viewed from the ±X direction or the ±Z direction orthogonal to the direction of extension of the support part 72, the engaging part 73 can be made less likely to be observed from outside. Therefore, the appearance of the projector device 1 can be improved.

In the projector device 1, the support part 72 is formed of one rod-shaped member.

According to such a configuration, the coupling member 6 and the support part 72 can be easily coupled together and an increase in the number of components of the projector device 1 can be suppressed, as compared with when the support part 72 coupled to the coupling member 6 is configured with a plurality of rod-shaped members.

In the projector device 1, the projector main body 2 includes the image forming device 41 forming image light, the base 46 supporting the image forming device 41, and the exterior housing 3 accommodating the image forming device 41 and the base 46. The coupling member 6 is attached to the base 46.

Here, the base 46 supporting the image forming device 41 is required to have a relatively high strength.

Since the coupling member 6 is attached to the such base 46, the coupling member 6 can be stably attached to the projector main body 2. Also, since there is no intervening object between the coupling member 6 and the base 46, the distance between the center of gravity P of the projector main body 2 and the rotation axis Rx can be made shorter. Therefore, the above-described torque can be further reduced, and the operability of the projector main body 2 can be further improved.

In the projector device 1, the center of gravity P of the projector main body 2 and the coupling member 6 attached to the projector main body 2 overlap each other when viewed from the top surface 33 side.

According to such a configuration, the rotation axis Rx and the center of gravity P of the projector main body 2 can be prevented from being far apart from each other as viewed from the +Y direction. Since the distance between the rotation axis Rx of the coupling member 6 and the center of gravity P of the projector main body 2 can thus be reduced, the above-described torque can be reduced. Therefore, the operability of the projector main body 2 can be further improved.

The projector device 1 includes the projector main body 2, the projector support part SP supporting the projector main body 2, and the installation base 71, where the projector support part SP is disposed.

The projector support part SP has the support part 72 erected from the installation base 71, and the coupling member 6. The coupling member 6 is coupled to one end of the support part 72 and is thus disposed at one end of the projector support part SP. The coupling member 6 is equivalent to the rotating part, is fixed to the projector main body 2, and supports the projector main body 2 rotatably about the rotation axis Rx orthogonal to the direction of extension of the projector support part SP.

The coupling member 6 is covered by the projector main body 2 in the circumferential direction about the axis along the direction of extension of the support part 72.

According to such a configuration, since the coupling member 6 supporting the projector main body 2 rotatably around the rotation axis Rx is covered by the projector main body 2 in the circumferential direction around the axis along the +Y direction, the coupling member 6 is disposed inside the projector main body 2. According to this configuration, the distance between the rotation axis Rx of the coupling member 6 and the center of gravity P of the projector main body 2 can be made shorter than when the coupling member 6 as the rotation part is into contact with the bottom surface 34 of the projector main body 2. Therefore, since the torque for rotating the projector main body 2 around the rotation axis Rx can be reduced, the operability for rotating the projector main body 2 can be improved.

### Modifications of Embodiment

The present disclosure is not limited to the above embodiment, and modifications, improvements, and the like in a range in which the object of the present disclosure can be achieved should fall within the scope of the present disclosure.

In the above embodiment, the entire coupling member 6 forming the coupling part provided in the projector PJ of the projector device 1 is disposed in the recess 341 recessed from the bottom surface 34 toward the top surface 33. However, the present disclosure is not limited thereto, and at least a part of the coupling member 6 may be disposed in the recess 341. Also, as long as the coupling position between the projector main body 2 and the coupling member 6 is located between the top surface 33 and the bottom surface, the coupling member 6 may not necessarily be provided in the recess 341. For example, when the bottom surface 34 includes a protruding part protruding from the bottom surface 34 into the direction opposite to the top surface 33, the coupling member 6 may be attached to the bottom surface 34.

In the above embodiment, when the projector device 1 is viewed from the top surface 33 side, the center of gravity P of the projector main body 2 and the coupling part 38 formed by the coupling member 6 overlap each other. However, the present disclosure is not limited thereto, and as the coupling member 6 supporting the projector main body 2 rotatably about the rotation axis Rx is disposed in the recess 341 recessed from the bottom surface 34 toward the top surface 33, the distance between the center of gravity P and the rotation axis Rx can be made shorter than when the coupling member 6 is coupled to the bottom surface 34. Therefore, the center of gravity P and the coupling part 38 may not overlap each other as viewed from the top surface 33 side.

In the above embodiment, the coupling member 6 attached to the projector main body 2 is covered by the front surface 31, the back surface 32, the right side surface 35, and the left side surface 36. Each of the front surface 31, the back surface 32, the right side surface 35, and the left side surface 36 is equivalent to the side surface coupling the top surface 33 and the bottom surface 34. However, at least one of the front surface 31, the back surface 32, the right side surface 35, and the left side surface 36 may not cover the coupling member 6.

In the above embodiment, the coupling member 6 and the stand 7 are coupled to each other by fixing the screw SC1 inserted through the hole part 612 of the mounting part 61 of the coupling member 6 to the screw hole 74 of the engaging part 73 of the support part 72. However, the form of coupling between the support part 72 and the coupling member 6 is not limited to the above. That is, it is sufficient that the support part 72 and the coupling member 6 can be coupled together, and the form of coupling between the support part 72 and the coupling member 6 can be changed as appropriate. For example, in a state where the coupling member 6 has a screw hole, the support part 72 has a hole part, and the mounting part 61 of the coupling member 6 is inserted into the support part 72 from the +Y direction, the screw SC1 inserted through the hole part of the support part 72 may be fixed to the screw hole of the coupling member 6. Also, for example, the coupling member 6 and the stand 7 may be fixed by bonding and fixing the mounting part 61 and the engaging part 73 together.

Also, when the coupling member 6 attached to the projector main body 2 is combined with the stand 7, the mounting part 61 of the coupling member 6 and the engaging part 73 of the stand 7 are surrounded by the projector main body 2. However, the mounting part 61 and the engaging part 73 are not limited thereto and may be exposed to the outside of the projector main body 2.

In the above embodiment, the support part 72 is configured with one rod-shaped member. However, the support part 72 is not limited thereto and may be configured with a plurality of rod-shaped members, like a tripod. Also, the support part 72 may be configured to be expandable and contractible along a direction perpendicular to the installation base 71.

In the above embodiment, the coupling member 6 is attached to the attachment part 461 of the base 46 supporting the image forming device 41 in the upper housing part 3A of the exterior housing 3. As illustrated in FIGS. 8 and 11, the attachment part 461 is exposed in the −Y direction through an opening 343 provided in a bottom part 342 facing the −Y direction in the recess 341, and the contact part 64 of the coupling member 6 attached to the attachment part 461 is disposed in the opening 343. However, the coupling member 6 is not limited thereto and may be attached to a structure other than the base 46. For example, the coupling member 6 may be attached to the inner surface of the recess 341 provided at the bottom surface 34, or may be attached to the bottom part 342 of the recess 341.

In the above embodiment, the image forming device 41 of the projector main body 2 includes the three light modulation elements 43R, 43G, 43B. However, the present disclosure is not limited thereto and is also applicable to a projector main body including two or fewer, or four or more light modulation elements.

In the above embodiment, the light source device 42, the light modulation device 43, the light combining device 44, and the projection optical device 45 forming the image forming device 41 are disposed in the layout shown in FIG. 3. However, the present disclosure is not limited thereto, and the optical components forming the image forming device 41 and the layout of the optical components can be changed as appropriate. For example, the light source device 42 may be a light source device that emits white light, and the image forming device 41 may include a color separation device that separates the white light emitted from the light source device 42 into red light, green light, and blue light.

In the above embodiment, each of the light modulation elements 43R, 43G, 43B is a transmissive liquid crystal light valve in which the light incident surface and the light exiting surface are different. However, each of the light modulation elements 43R, 43G, 43B is not limited thereto and may be a reflective liquid crystal light valve in which the light incident surface and light exiting surface are the same. Also, other than the liquid crystal light modulation element, any light modulation element that can modulate an incident light flux to form an image corresponding to image information may be used, such as a light modulation element using a device using micromirrors, for example, a digital micromirror device (DMD).

### Summary of Present Disclosure

The present disclosure will be summarized below as appendices.

### Appendix 1

A projector device includes: an installation base installed at an installation surface; a support part erected from the installation base; a coupling part having a rotation axis along a direction orthogonal to a direction of extension of the support part and provided at one end of the support part; and a projector main body coupled to the coupling part so as to be rotationally movable about the rotation axis with respect to the support part, and the projector main body has a bottom surface located on the installation base side, a top surface opposite to the bottom surface, and a recess recessed from the bottom surface toward the top surface, and at least a part of the coupling part coupled to the projector main body is disposed in the recess.

Here, the torque for rotating the projector main body around the rotation axis increases according to the distance between the rotation axis and the center of gravity of the projector main body.

However, the coupling position of the coupling part with respect to the projector main body can be brought closer to the top surface side than when the coupling part is coupled to the bottom surface, and therefore the rotation axis and the center of gravity of the projector main body can be prevented from being far apart from each other. Since the distance between the rotation axis of the coupling part and the center of gravity of the projector main body can thus be reduced, the above-described torque can be reduced. Therefore, the operability for rotating the projector main body can be improved.

### Appendix 2

In the projector device according to Appendix 1, the projector main body is coupled to the coupling part between the bottom surface and the top surface.

According to such a configuration, the distance between the center of gravity of the projector main body and the rotation axis of the coupling part can be made shorter than when the projector main body is coupled to the coupling part at the bottom surface. Therefore, since the above-described torque can be further reduced, the operability for rotating the projector main body can be improved further.

### Appendix 3

In the projector device according to Appendix 1 or 2, the projector main body has a side surface that couples the top surface and the bottom surface, and a first distance between the rotation axis and a center of gravity of the projector main body is shorter than a second distance between the center of gravity of the projector main body and the bottom surface, as viewed from a direction perpendicular to the side surface.

According to such a configuration, as described above, the distance between the center of gravity of the projector main body and the rotation axis of the coupling part can be made shorter than when the projector main body is coupled to the coupling part at the bottom surface. Therefore, since the above-described torque can be further reduced, the operability for rotating the projector main body can be improved further.

### Appendix 4

In the projector device according to any one of Appendices 1 to 3, the projector main body has a side surface that couples the top surface and the bottom surface, and the coupling part is covered by the side surface, as viewed from a direction perpendicular to the side surface.

According to such a configuration, since the projector main body has the side surface covering the coupling part, the center of gravity of the projector main body can be easily brought close to the coupling part. Thus, the distance between the center of gravity of the projector main body and the rotation axis can be easily reduced, and the above-described torque can be easily reduced.

Also, since the coupling part is covered by the side surface, the coupling part can be made less likely to be observed from outside. Therefore, the appearance of the projector device can be improved.

### Appendix 5

In the projector device according to any one of Appendices 1 to 4, the support part includes an engaging part that engages with the coupling part, and when the coupling part and the engaging part engage with each other, the engaging part is covered by the projector main body, as viewed from a direction orthogonal to the direction of extension.

According to such a configuration, since the engaging part, which is the part of the support part engaged with the coupling part, is covered by the projector main body as viewed from the direction orthogonal to the direction of extension of the support part, the engaging part can be made less likely to be observed from outside. Therefore, the appearance of the projector device can be improved.

### Appendix 6

In the projector device according to any one of Appendices 1 to 5, the support part is configured with one rod-shaped member.

According to such a configuration, the coupling part and the support part can be easily coupled together and an increase in the number of components of the projector device can be suppressed, as compared with when the support part coupled to the coupling part is configured with a plurality of rod-shaped members.

### Appendix 7

In the projector device according to any one of Appendices 1 to 6, the projector main body includes an image forming device that forms image light, a base that supports the image forming device, and an exterior housing that accommodates the image forming device and the base, and the coupling part is attached to the base.

Here, the base that supports the image forming device is required to have a relatively high strength.

Since the coupling part is attached to such a base, the coupling part can be stably attached to the projector main body. Also, when there is no intervening object between the coupling part and the base, the distance between the center of gravity of the projector main body and the rotation axis can be made shorter. Therefore, the above-described torque can be further reduced, and the operability of the projector main body can be further improved.

### Appendix 8

In the projector device according to any one of Appendices 1 to 6, the center of gravity of the projector main body and the coupling part overlap each other when viewed from the top surface side.

According to such a configuration, since the center of gravity of the projector main body and the coupling part overlap each other when viewed from the top surface side, the center of gravity of the projector main body and the rotation axis can be brought closer to each other. Therefore, the operability of the projector main body can be further improved.

### Appendix 9

A projector device includes: a projector main body; a projector support part that supports the projector main body; and an installation base where the projector support part is disposed, and the projector support part includes a rotating part that is disposed at one end of the projector support part, is fixed to the projector main body, and supports the projector main body rotatably about a rotation axis orthogonal to a direction of extension of the projector support part, and the rotating part is covered by the projector main body in a circumferential direction about an axis along the direction of extension.

According to such a configuration, since the rotating part that supports the projector main body rotatably around the rotation axis is covered by the projector main body, the rotating part is disposed inside the projector main body. According to this configuration, the distance between the rotation axis of the rotating part and the center of gravity of the projector main body can be made shorter than when the rotating part is in contact with the bottom surface of the projector main body. Therefore, similarly to the above, since the torque for rotating the projector main body around the rotation axis can be reduced, the operability for rotating the projector main body can be improved.

What is claimed is:

1. A projector device comprising:
an installation base installed at an installation surface;
a support part erected from the installation base;
a coupling part having a rotation axis along a direction orthogonal to a direction of extension of the support part and provided at one end of the support part; and
a projector main body coupled to the coupling part so as to be rotationally movable about the rotation axis with respect to the support part, wherein
the projector main body includes
a bottom surface located on the installation base side,
a top surface opposite to the bottom surface, and
a recess recessed from the bottom surface toward the top surface, and
at least a part of the coupling part coupled to the projector main body is disposed in the recess.

2. The projector device according to claim 1, wherein
the projector main body is coupled to the coupling part between the bottom surface and the top surface.

3. The projector device according to claim 1, wherein
the projector main body has a side surface that couples the top surface and the bottom surface, and
a first distance between the rotation axis and a center of gravity of the projector main body is shorter than a second distance between the center of gravity of the projector main body and the bottom surface, as viewed from a direction perpendicular to the side surface.

4. The projector device according to claim 1, wherein
the projector main body has a side surface that couples the top surface and the bottom surface, and
the coupling part is covered by the side surface, as viewed from a direction perpendicular to the side surface.

5. The projector device according to claim 1, wherein
the support part includes an engaging part that engages with the coupling part, and
when the coupling part and the engaging part engage with each other, the engaging part is covered by the projector main body, as viewed from a direction orthogonal to the direction of extension.

6. The projector device according to claim 1, wherein
the support part is configured with one rod-shaped member.

7. The projector device according to claim 1, wherein
the projector main body includes
an image forming device that forms image light,
a base that supports the image forming device, and
an exterior housing that accommodates the image forming device and the base, and
the coupling part is attached to the base.

8. The projector device according to claim 1, wherein
the center of gravity of the projector main body and the coupling part overlap each other when viewed from the top surface side.

9. A projector device comprising:
a projector main body;
a projector support part that supports the projector main body; and
an installation base where the projector support part is disposed, wherein
the projector support part includes a rotating part that is disposed at one end of the projector support part, is fixed to the projector main body, and supports the projector main body rotatably about a rotation axis orthogonal to a direction of extension of the projector support part, and
the rotating part is covered by the projector main body in a circumferential direction about an axis along the direction of extension.
